(19) United States
(12) Patent Application Publication
(10) Pub. No.: US 2018/0026262 A1
(43) Pub. Date: Jan. 25, 2018

(54) NEGATIVE ACTIVE MATERIAL, LITHIUM BATTERY INCLUDING THE SAME, AND METHOD OF PREPARING THE NEGATIVE ACTIVE MATERIAL

(71) Applicant: SAMSUNG SDI CO., LTD., Yongin-si (KR)

(72) Inventors: Changui JEONG, Yongin-si (KR); Jiyeon KWAK, Yongin-si (KR); Yeongap KIM, Yongin-si (KR); Youngugk KIM, Yongin-si (KR); Uisong DO, Yongin-si (KR); Sangeun PARK, Yongin-si (KR); Yuntaek OH, Yongin-si (KR); Yongchan YOU, Yongin-si (KR); Inoh CHA, Yongin-si (KR); Heeseon CHOI, Yongin-si (KR)

(21) Appl. No.: 15/621,521

(22) Filed: Jun. 13, 2017

(30) Foreign Application Priority Data
Jul. 19, 2016 (KR) 10-2016-0091440

(51) Int. Cl. H01M 4/36; H01M 10/0525; H01M 10/0568; H01M 4/587; H01M 4/525; H01M 10/0569; H01M 4/04; H01M 4/38

(52) U.S. Cl. CPC H01M 4/366; H01M 4/0471; H01M 10/0525; H01M 4/364; H01M 4/386; H01M 4/587; H01M 4/0435; H01M 4/525; H01M 10/0569; H01M 10/0568; H01M 2004/027

(57) ABSTRACT

A negative active material includes a silicon-based material core and a pitch coating layer on a surface of the silicon-based material core. The pitch coating layer includes a mesophase pitch.

### CROSS-REFERENCE TO RELATED APPLICATION

Korean Patent Application No. 10-2016-0091440, filed on Jul. 19, 2016, in the Korean Intellectual Property Office, and entitled: “Negative Active Material, Lithium Battery Including the Same, and Method of Preparing the Negative Active Material,” is incorporated by reference herein in its entirety.

### BACKGROUND

### 1. Field

Embodiments relate to negative active materials, lithium batteries including the same, and methods of preparing the negative active materials.

### 2. Description of the Related Art

Lithium batteries, in particular, lithium secondary batteries, have been used as power sources for portable IT devices, electric vehicles, or power storage application due to high energy density and easy design thereof. Such lithium secondary batteries require high energy density and/or long lifespan.

### SUMMARY

Embodiments are directed to a negative active material including a silicon-based material core, and a pitch coating layer on a surface of the silicon-based material core. The pitch coating layer includes a mesophase pitch.

The negative active material may have a ratio (I_{D}/I_{G}) of an intensity (I_{D}) of a peak appearing at about 1300 cm⁻¹ to about 1400 cm⁻¹ to an intensity (I_{G}) of a peak appearing at about 1580 cm⁻¹ to about 1620 cm⁻¹ of about 1.0 or less, the intensities of the peaks being measured by Raman spectroscopy spectrum.

An amount of the pitch coating layer may be from about 1 wt % to about 40 wt % based on a total weight of the silicon-based material core.

An amount of the mesophase pitch may be from about 30 wt % to about 100 wt % based on a total weight of the pitch coating layer.

An amount of the mesophase pitch may be from about 30 wt % to about 90 wt % based on a total weight of the pitch coating layer.

An amount of the mesophase pitch may be from greater than about 70 wt % to about 90 wt % based on a total weight of the pitch coating layer.

The silicon-based material core may include one selected from silicon, a silicon-carbon composite, a silicon oxide, a silicon alloy, and combinations thereof.

The silicon-based material core may include a silicon-carbon composite.

The negative active material may have a median particle diameter D50 of about 1 μm to about 20 μm.

Embodiments are also directed to a lithium battery including a negative electrode including the negative active material as described above, a positive electrode including a positive active material, and an electrolyte between the negative electrode and the positive electrode.

Embodiments are also directed to a method of preparing a negative active material as described above. The method includes mixing a silicon-based material core and a pitch including a mesophase pitch and compression-molding the mixture to obtain a compression-molded product and heat-treating the compression-molded product to prepare the negative active material.

The heat-treating may be performed in an inert gas atmosphere at a temperature in a range of from about 400° C. to about 1,100° C.

The inert gas atmosphere may include one selected from a nitrogen gas atmosphere, a hydrogen gas atmosphere, and combinations thereof.

The method may further include pulverizing the heat-treated compression-molded product.

### BRIEF DESCRIPTION OF THE DRAWINGS

Features will become apparent to those of skill in the art by describing in detail exemplary embodiments with reference to the attached drawings in which:

FIG. 1 illustrates a schematic view of a structure of a negative active material according to an embodiment;

FIG. 2 illustrates a schematic view of a structure of a lithium secondary battery according to an embodiment;

FIG. 3 illustrates a graph showing Raman spectroscopy spectra of negative active materials prepared according to Examples 1 to 4 and Comparative Example 1; and

FIG. 4 illustrates a graph showing lifespan characteristics of lithium secondary batteries manufactured according to Examples 5 to 8 and Comparative Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The term “silicon-based material” as used herein refers to a material including at least 5% silicon. For example, the silicon-based material may include at least 10% silicon, at least 20% silicon, at least 30% silicon, at least 40% silicon, at least 50% silicon, at least 55% silicon, at least 60% silicon. at least 65% silicon, at least 70% silicon, at least 75% silicon, at least 80% silicon, at least 85% silicon, at least 90% silicon, or at least 95% silicon.

The terms “including” and “comprising” as used herein do not preclude the presence of other elements and indicate addition and/or intervention of other elements, unless otherwise specified herein.

The term “a combination thereof” as used herein indicates a mixture or combination of two or more components described.

Expressions such as “at least one of,” when preceding a list of elements, modify the entire list of elements and do not modify the individual elements of the list.

Generally, when a negative active material such as a silicon-based material is used alone, one silicon atom may react with a maximum of 4.4 lithium atoms. Due to this, during charging and discharging of a lithium battery including the negative active material, the negative active material may undergo volumetric expansion up to a maximum of 400% and cracks may occur irregularly in particles of the negative active material. An SEI film may be formed by electrolyte decomposition on surfaces of the negative active material particles with the cracks irregularly formed therein. However, the negative active material particles with the cracks irregularly formed therein may not be able to participate in an electrochemical reaction and a lithium battery including the same may exhibit capacity loss and decreased lifespan.

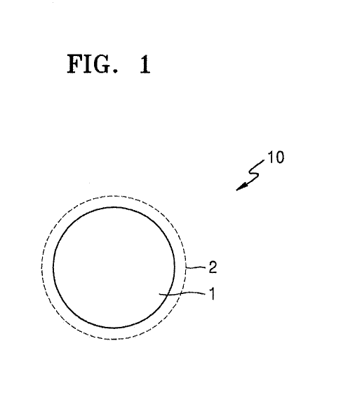

As schematically illustrated in FIG. 1, a negative active material 10 according to an embodiment may include a silicon-based material core 1 and a pitch coating layer 2 on a surface of the silicon-based material core. The pitch coating layer 2 includes a mesophase pitch.

The pitch coating layer may include a mesophase pitch having an optically anisotropic property in which molecules constituting the pitch are oriented in a liquid state. Unlike isotropic pitches in which molecules constituting the same are randomly oriented, such a mesophase pitch is highly crystalline even in a liquid state.

The negative active material may have a ratio (I_{D}/I_{G}) of intensity (I_{D}) of a peak appearing at about 1300 cm⁻¹ to about 1400 cm⁻¹ to intensity (I_{G}) of a peak appearing at about 1580 cm⁻¹ to about 1620 cm⁻¹ of about 1.0 or less, the intensities of the two peaks being measured by Raman spectroscopy. For example, the ratio (I_{D}/I_{G}) of intensity (I_{D}) of a peak appearing at about 1300 cm⁻¹ to about 1400 cm⁻¹ to intensity (I_{G}) of a peak appearing at about 1580 cm⁻¹ to about 1620 cm⁻¹ of the negative active material may range from about 0.6 to about 1.0.

The negative active material may be a carbon material having high crystallinity and a high intensity (I_{G}) of the peak appearing at about 1580 cm⁻¹ to about 1620 cm⁻¹, and thus, the intensity ratio (I_{D}/I_{G}) may be about 1.0 or less.

In such a negative active material, it may be easy to form the pitch coating layer on the surface of the silicon-based material core even under low heat treatment conditions. In the pitch coating layer, a polymer may be low in content and viscosity thereof is low in a liquid state.

Thus, pitch may permeate into fine empty spaces in the surface of the silicon-based material core to thereby form a uniform coating layer. Accordingly, the occurrence of cracks in the silicon-based material core may be minimized during charging and discharging of a lithium battery including the negative active material, thus enhancing capacity and lifespan characteristics thereof.

An amount of the pitch coating layer may range from about 1 wt % to about 40 wt % based on a total weight of the silicon-based material core. When the amount of the pitch coating layer is within the above range, volumetric expansion of the silicon-based material may be decreased and a lithium battery including the same may have enhanced lifespan characteristics.

An amount of the mesophase pitch in the pitch coating layer may range from about 30 wt % to about 100 wt % based on a total weight of the pitch coating layer.

For example, the amount of the mesophase pitch may range from about 30 wt % to about 90 wt % based on the total weight of the pitch coating layer. For example, the amount of the mesophase pitch may range from greater than about 70 wt % to about 90 wt % based on the total weight of the pitch coating layer.

In some implementations, the amount of the mesophase pitch may be 100 wt % based on the total weight of the pitch coating layer. In some implementations, the pitch coating layer may be a mixed pitch coating layer of a mesophase pitch and a general pitch. When the pitch coating layer is such a mixed pitch coating layer thereof, the mesophase pitch may not leak out of the negative active material and may form a more uniform pitch coating layer due to high wettability thereof. Thus, a lithium battery including the negative active material may have further enhanced capacity and lifespan characteristics.

In this regard, a suitable general pitch used in the art may be used. Examples of suitable general pitches include coal-based pitches, petroleum-based pitches, and organic synthetic pitches.

The silicon-based material core may include silicon, a silicon-carbon composite, a silicon oxide, a silicon alloy, or a combination thereof.

The silicon oxide may be, for example, SiOₓ where 0<x<2.

The silicon alloy may be, for example, a Si—Z′ alloy wherein Z′ is at least one element selected from an alkali metal, an alkali earth metal, a Groups 13 or 14 element, a transition metal, and a rare earth element, (provided that Z′ is not Si).

For example, the silicon-based material core may include a silicon-carbon composite.

The silicon-carbon composite may be in the form of silicon particles and/or carbon-silicon composite particles in a carbon matrix. The silicon particles may exist, in the carbon matrix, in the form of primary particles or secondary particles formed by agglomeration of primary particles.

The negative active material may have a median particle diameter D50 of about 1 μm to about 20 μm, or, for example, about 1 μm to about 18 μm, or, for example, about 1 μm to about 15 μm.

The term “median particle diameter D50” as used herein indicates, assuming that a total number of particles is 100%, the value of particle size at which 50% of particles are smaller on a cumulative distribution curve represented in the order of the smallest particles to the largest particles. The D50 value may be measured using one of various methods well known in the art, for example, using a particle size analyzer, or deriving the particle size from a transmission electron microscopy (TEM) image or a scanning electron microscopy (SEM) image. For example, by performing a measurement using a measurement device using dynamic light-scattering and then performing data analysis on the measured values to count the number of particles for each particle size range, the D50 value may be easily obtained by calculation therefrom.

A lithium battery may include a negative electrode including the negative active material described above, a positive electrode including a positive active material, and an electrolyte between the negative electrode and the positive electrode.

The negative electrode may be manufactured as follows.

A negative active material, a conductive material, a binder, and a solvent may be mixed to prepare a negative electrode slurry composition. The negative electrode slurry composition may be directly coated onto a negative current collector, and the resulting negative current collector may be dried to thereby complete the manufacture of a negative electrode including a negative active material layer. In another embodiment, the negative electrode slurry composition may be cast onto a separate support and a film separated from the support may be laminated on a negative current collector to thereby complete the manufacture of a negative electrode including a negative active material layer.

As the negative active material, the negative active material described above may be used.

In addition, the negative active material may include a suitable negative active material used as a negative active material of a lithium battery. For example, the negative active material may further include at least one selected from lithium metal, a metal alloyable with lithium, a transition metal oxide, a non-transition metal oxide, and a carbonaceous material.

For example, the metal alloyable with lithium may be silicon (Si), tin (Sn), aluminum (Al), germanium (Ge), lead (Pb), bismuth (Bi), antimony (Sb), a Si-yttrium (Y′) alloy, where Y′ is an alkali metal, an alkali earth metal, a Groups 13 or 14 element, a transition metal, a rare earth element, or a combination thereof (provided that Y′ is not Si), a Sn—Y′ alloy, where Y′ is an alkali metal, an alkali earth metal, a Groups 13 or 14 element, a transition metal, a rare earth element, or a combination thereof (provided that Y′ is not Sn), or the like. Examples of Y′ may include magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B). aluminum (Al), gallium (Ga), tin (Sn), indium (In), germanium (Ge), phosphorus (P), arsenic (As), antimony (Sb), bismuth (Bi), sulfur (S), selenium (Se), tellurium (Te). polonium (Po), and combinations thereof.

For example, the transition metal oxide may be lithium titanate oxide, vanadium oxide, lithium vanadium oxide, or the like.

For example, the non-transition metal oxide may be SnO₂, SiOₓ, where 0<x<2, or the like.

The carbonaceous material may be crystalline carbon, amorphous carbon, or a mixture thereof. Examples of the crystalline carbon include natural graphite and artificial graphite, each of which has an irregular form or is in the form of a plate, a flake, a sphere, or a fiber. Examples of the amorphous carbon include soft carbon (low-temperature calcined carbon), hard carbon, mesophase pitch carbonized product, and calcined coke.

A suitable conductive agent may be used. Examples of the conductive material include graphite particulates and natural or artificial graphite, carbon black, acetylene black, and Ketjen black, carbon fibers, carbon nanotubes, metal powders, fibers or tubes of copper, nickel, aluminum, and silver, and conductive polymers such as polyphenylene derivatives.

The binder may be either an aqueous binder or a non-aqueous binder. An amount of the binder may range from about 0.1 parts by weight to about 5 parts by weight based on a total weight (100 parts by weight) of the negative active material composition. When the amount of the binder is within the above range, adhesion between the negative electrode and a current collector may be high.

The aqueous binder may be styrene-butadiene rubber (SBR), a polyvinyl alcohol, carboxymethylcellulose, hydroxypropylcellulose, diacetylcellulose, or a mixture thereof.

For example, a SBR binder may be dispersed in water in an emulsion form and thus may not not require an organic solvent. The SBR binder may have high adhesive strength and, accordingly, a high-capacity lithium battery may be manufactured using the binder in a decreased amount and the negative active material in an increased amount. The aqueous binder may used together with an aqueous solvent such as water or an alcohol solvent miscible with water. When the aqueous binder is used, a thickening agent may be further used for adjustment of viscosity. The thickening agent may be at least one selected from carboxymethylcellulose, hydroxymethylcellulose, hydroxyethylcellulose, and hydroxypropylcellulose. An amount of the thickening agent may range from about 0.8 wt % to about 5 wt %, or, for example, about 1 wt % to about 5 wt %, or, for example, about 1 wt % to about 2 wt %, based on the total weight of the negative active material composition.

When the amount of the thickening agent is within the ranges described above, a current collector may be easily coated with a negative active material layer-forming composition without a decrease in capacity of a lithium battery.

The non-aqueous binder may be one selected from polyvinyl chloride, polyvinyl pyrrolidone, polytetrafluoroethylene, polyvinylidene fluoride, polyethylene, polypropylene, and mixtures thereof. These non-aqueous binders may be used together with a non-aqueous solvent selected from N-methyl-2-pyrrolidone (NMP), dimethylformamide, tetrahydrofuran, and mixtures thereof.

In some embodiments, the negative electrode slurry composition may further include a plasticizer to form pores in a negative electrode plate.

The amounts of the negative active material, the conductive material, the binder, and the solvent may be the same as those used in general lithium batteries.

The negative current collector may be fabricated to have a thickness of about 3 μm to about 500 μm. The negative current collector may be made of a suitable material that does not cause chemical change in the fabricated battery and that has conductivity. Examples of the negative current collector include copper, stainless steel, aluminum, nickel, titanium, sintered carbon, copper or stainless steel that is surface-treated with carbon, nickel, titanium, or silver, or a aluminum-cadmium alloy. In some implementations, the negative current collector may be processed to have fine irregularities on surfaces thereof so as to enhance the adhesion of the negative current collector to the negative active material. The negative current collector may be used in any of various forms including films, sheets, foils, nets, porous structures, foams, and non-woven fabrics.

The positive electrode may be manufactured using the same method as that used to manufacture the negative electrode, except that a positive active material is used instead of the negative active material.

As a positive active material slurry, a positive active material composition instead of the negative active material composition may be used.

For example, a positive active material, a conductive material, a binder, and a solvent may be mixed to prepare a positive electrode slurry composition. The positive electrode slurry composition may be directly coated onto a positive current collector and the resulting positive current collector may be dried to thereby complete the manufacture of a positive electrode having a positive active material layer. In another embodiment, the positive electrode slurry composition may be cast onto a separate support, and a film separated from the support may be laminated on a positive current collector to thereby complete the manufacture of a positive electrode having a positive active material layer.

As the positive active material, a suitable lithium-containing metal oxide commonly used in the art may be used. For example, the positive active material may be at least one selected from composite oxides of lithium and a metal selected from cobalt, manganese, nickel, and combinations thereof. For example, the positive active material may be a compound represented by any one of the following formulae: LiₐA_{1-b}B′_{b}D′₂ where 0.90≦a≦1 and 0≦b≦0.5; LiₐE_{1-b}B′_{b}O_{2-c}D′_{c} where 0.90≦a≦1, 0≦b≦0.5, and 0≦c≦0.05; LiE_{2-b}B′_{b}O_{4-c}D′_{c} where 0≦b≦0.5 and 0≦c≦0.05; LiₐNi_{1-b-c}Co_{b}B′_{c}D′_{α} where 0.90≦a≦1, 0≦b≦0.5, 0≦c≦0.05, and 0<α≦2; LiₐNi_{1-b-c}Co_{b}B′_{c}O_{2-α}F′_{α} where 0.90≦a≦1, 0≦b≦0.5, 0≦c≦0.05, and 0<α≦2; LiₐNi_{1-b-c}Co_{b}B′_{c}O_{2-α}F′₂ where 0.90≦a≦1, 0≦b≦0.5, 0≦c≦0.05, and 0<α≦2; LiₐNi_{1-b-c}Mn_{b}B′_{c}D′_{α} where 0.90≦a≦1, 0≦b≦0.5, 0≦c≦0.05, and 0<α≦2; LiₐNi_{1-b-c}Mn_{b}B′_{c}O_{2-α}F′_{α} where 0.90≦a≦1, 0≦b≦0.5, 0≦c≦0.05, and 0<α≦2; LiₐNi_{1-b-c}Mn_{b}B′_{c}O_{2-α}F′₂ where 0.90≦a≦1. 0≦b≦0.5, 0≦c≦0.05, and 0<α≦2; LiₐNi_{b}E_{c}G_{d}O₂ where 0.90≦a≦1, 0≦b≦0.9, 0≦c≦0.5, and 0.001≦d≦0.1; LiₐNi_{b}Co_{c}Mn_{d}GₑO₂ where 0.90≦a≦1, 0≦b≦0.9, 0≦c≦0.5, 0≦d≦0.5, and 0.001≦e≦0.1; LiₐNiG_{b}O₂ where 0.90≦a≦1 and 0.001≦b≦0.1; LiₐCoG_{b}O₂ where 0.90≦a≦1 and 0.001≦b≦0.1; LiₐMnG_{b}O₂ where 0.90≦a≦1 and 0.001≦b≦0.1; LiₐMn₂G_{b}O₄ where 0.90≦a≦1 and 0.001≦b≦0.1; QO₂; QS₂; LiQS₂; V₂O₅; LiV₂O₅; LiI′O₂; LiNiVO₄; Li_{(3-f)}J₂(PO₄)₃ where 0≦f≦2; Li_{(3-f)}Fe₂(PO₄)₃ where 0≦f≦2; and LiFePO₄.

In the formulae above, A is nickel (Ni), cobalt (Co), manganese (Mn), or a combination thereof; B′ is aluminum (Al), Ni, Co, Mn, chromium (Cr), iron (Fe), magnesium (Mg), strontium (Sr), vanadium (V), a rare earth element, or a combination thereof; D′ is oxygen (O), fluorine (F), sulfur (S), phosphorus (P), or a combination thereof; E is Co, Mn, or a combination thereof; F′ is F, S, P, or a combination thereof; G is Al, Cr, Mn, Fe, Mg, lanthanum (La), cerium (Ce), strontium (Sr), V, or a combination thereof; Q is titanium (Ti), molybdenum (Mo), Mn, or a combination thereof; I′ is Cr, V, Fe, scandium (Sc), yttrium (Y), or a combination thereof; and J is V, Cr, Mn, Co, Ni, copper (Cu), or a combination thereof.

The compounds described above having a coating layer on their surfaces may be used, or the compounds described above and the compounds described above having a coating layer on their surfaces may be used in combination. The coating layer may include a coating element compound, such as an oxide of a coating element, a hydroxide of a coating element, an oxyhydroxide of a coating element, an oxycarbonate of a coating element, or a hydroxycarbonate of a coating element. The coating element compounds may be amorphous or crystalline. The coating element included in the coating layer may be Mg, Al, Co, K, Na, Ca, Si, Ti, V, Sn, Ge, Ga, B, As, Zr, or a mixture thereof. A coating layer may be formed using the coating elements in the aforementioned compounds by using any one of various coating methods (e.g., spray coating or immersion) that do not adversely affect physical properties of the positive active material.

The amounts of the positive active material, the conductive material, the binder, and the solvent may be the same as those used in general lithium batteries. At least one of the conductive material, the binder, and the solvent may be omitted according to a use and constitution of desired lithium batteries.

The positive current collector may be fabricated to a thickness of about 3 μm to about 500 μm. The positive current collector may be made of a suitable material that does not cause chemical change in the fabricated battery and that has conductivity. Non-limiting examples of the positive current collector include copper, stainless steel, aluminum, nickel, titanium, sintered carbon, copper or stainless steel that is surface-treated with carbon, nickel, titanium, or silver, and aluminum-cadmium alloys. In some implementations, the positive current collector may be processed to have fine irregularities on surfaces thereof so as to enhance the adhesion of the positive current collector to the positive active material, and may be used in any of various forms including films, sheets, foils, nets, porous structures, foams, and non-woven fabrics.

The positive electrode may have a mixed density of at least 2.0 g/cc.

Next, a separator to be disposed between the negative electrode and the positive electrode may be prepared.

The positive electrode and the negative electrode may be separated from each other by a separator. A suitable separator commonly used in lithium batteries may be used. For example. a separator having low resistance to the transfer of ions in an electrolyte and having an excellent electrolyte-retaining ability may be used. For example, the separator may be made of one selected from glass fiber, polyester, Teflon, polyethylene, polypropylene, polytetrafluoroethylene (PTFE), and combinations thereof, each of which may be a non-woven or woven fabric. The separator may have a pore diameter of about 0.01 μm to about 10 μm and may have a thickness of about 5 μm to about 300 μm. For example, the separator may be manufactured using the method as follows.

A separator composition may be prepared by mixing a polymer resin, a filler, and a solvent. The separator composition may be directly coated onto an electrode and dried to thereby complete the fabrication of a separator. In other embodiments, the separator composition may be cast onto a support and dried, and then a separator film separated from the support may be laminated on an electrode to thereby complete the fabrication of a separator.

A polymer resin used in the fabrication of a separator and a suitable material used as a binder for electrode plates may be used. For example, the polymer resin may be one selected from a vinylidenefluoride/hexafluoropropylene copolymer, polyvinylidenefluoride (PVDF), polyacrylonitrile, polymethylmethacrylate, and mixtures thereof.

Next, an electrolyte may be prepared.

The electrolyte may be, for example, an organic electrolytic solution. In some implementations, the electrolyte may be solid. A suitable solid electrolyte used in lithium secondary batteries may be used. For example, the electrolyte may be a boron oxide, lithium oxynitride, or the like. any. The solid electrolyte may be disposed on the negative electrode by using a method, such as sputtering.

An organic electrolytic solution may be prepared, for example, by dissolving a lithium salt in an organic solvent.

The organic solvent may be a suitable organic solvent used in the art. Non-limiting examples of the organic solvent include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, y-butyrolactone, dioxolane, 4-methyldioxolane, N,N-dimethylformamide, dimethylacetamide, dimethylsulfoxide, dioxane, 1,2-dimethyoxyethane, sulfolane, dichloroethane, chlorobenzene, nitrobenzene, diethyleneglycol, dimethylether, and mixtures thereof.

The lithium salt may be a suitable lithium salt used in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) where x and y are natural numbers, LiCl, LiI, a mixture thereof, or the like.

The lithium battery may be a lithium primary battery or a lithium secondary battery. For example, the lithium battery may be a lithium secondary battery.

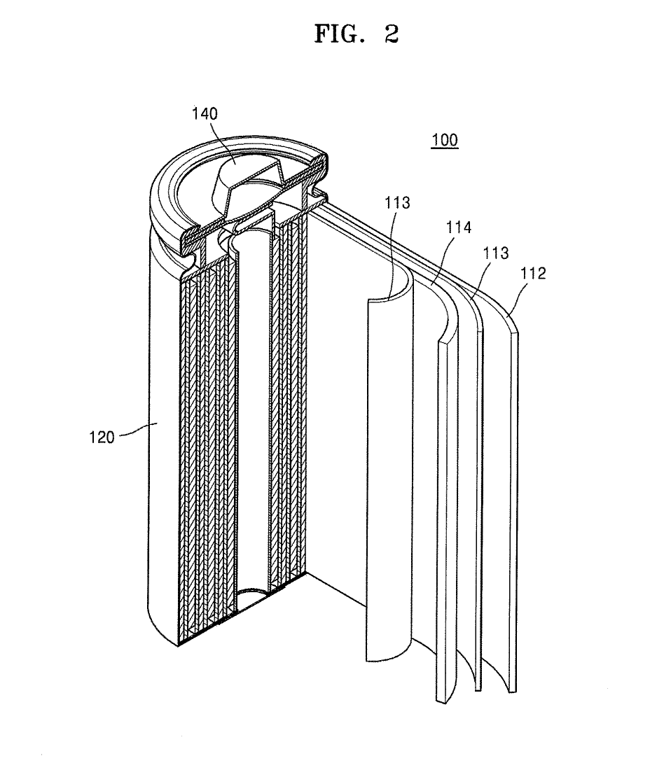

FIG. 2 illustrates an exploded perspective view of a lithium secondary battery 100 according to an embodiment.

The lithium secondary battery 100 may include a positive electrode 114, a separator 113, and a negative electrode 112, as described above. The positive electrode 114, the separator 113, and the negative electrode 112 may be wound or folded, and then accommodated in a battery case 120. Subsequently, an organic electrolytic solution may be injected into the battery case 120 and the battery case 120 may be sealed by a sealing member 140 to thereby complete the manufacture of the lithium secondary battery 100. The battery case 120 may have a cylindrical shape, a rectangular shape, a thin-film shape, or the like. In some implementations, the lithium secondary battery may be a lithium-ion battery including a battery assembly. Two battery assemblies may be stacked in a bi-cell structure and impregnated with an organic electrolytic solution. The resulting structure may be accommodated in a pouch and sealed therein to thereby complete the manufacture of a lithium-ion polymer battery.

In some implementations, the lithium secondary battery may be, for example, a large-scale thin film-type battery.

In some implementations, battery assemblies may be stacked to form a battery pack. The battery pack may be used in a device requiring high capacity and high power output. For example, the battery pack may be used in laptop computers, smart phones, motor-driven tools, electric vehicles, or the like.

In some implementations, the lithium secondary battery may be used in electric vehicles (EVs). For example, the lithium secondary battery may be used in hybrid vehicles such as plug-in hybrid electric vehicles (PHEVs), or the like.

A method of preparing the negative active material according to an implementation may include mixing a silicon-based material core and a pitch including a mesophase pitch, compression-molding the mixture to obtain a compression-molded product, and heat-treating the compression-molded product to prepare the negative active material described above.

A suitable method may be used for the mixing of the silicon-based material core and the pitch including a mesophase pitch. For example, the mixing process may be performed using a mechanical stirrer or the like. In addition, a suitable method may be used for the compression-molding process. For example, the compression-molding process may be performed by filling a molding machine with the mixture and applying a constant pressure thereto.

The heat treatment process may be performed in an inert gas atmosphere at a temperature of about 400° C. to about 1,100° C. For example, the heat treatment process may be performed in an inert gas atmosphere at about 600° C. for about 1 hour to about 5 hours. The inert gas atmosphere may be a nitrogen gas atmosphere, a hydrogen gas atmosphere, or a combination thereof. For example, the inert gas atmosphere may be a nitrogen gas atmosphere.

Even when the heat treatment process is performed in the low temperature ranges as described above, the negative active material formed thereby may include a mesophase pitch having high crystallinity. Thus a pitch coating layer may be easily formed on a surface of the silicon-based material core.

Preparing the negative active material may further include a pulverizing process.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

Preparation of Negative Active Material

### Example 1

### Preparation of Negative Active Material

A silicon-carbon composite powder (median particle diameter: about 38 μm, manufactured by BTR) and a pitch powder having a median particle diameter of about 3 μm, and including about 30% mesophase pitch (manufactured by Graphite Fiber) were mixed in a tubular mixer at 100 rpm for 30 minutes to obtain a mixture. The mixture was loaded into a molding machine and compressed to obtain a compression-molded product. The compression-molded product was heat-treated in a nitrogen atmosphere at 600° C. for 2 hours. The heat-treated resultant was pulverized and classified to obtain a negative active material having a median particle diameter D50 of 15 μm.

### Example 2

### Preparation of Negative Active Material

A negative active material was prepared in the same manner as in Example 1, except that a pitch powder having a median particle diameter of about 3 μm and including about 70% mesophase pitch (manufactured by Graphite Fiber) was used instead of the pitch powder described in Example 1.

### Example 3

### Preparation of Negative Active Material

A negative active material was prepared in the same manner as in Example 1, except that a pitch powder having a median particle diameter: about 3 μm and including about 90% mesophase pitch (manufactured by Graphite Fiber) was used instead of the pitch powder described in Example 1.

### Example 4

### Preparation of Negative Active Material

A negative active material was prepared in the same manner as in Example 1, except that a pitch powder having a median particle diameter of about 3 μm and including about 100% mesophase pitch (manufactured by Graphite Fiber) was used instead of the pitch powder described in Example 1.

### Comparative Example 1

### Preparation of Negative Active Material

A negative active material was prepared in the same manner as in Example 1, except that petroleum-based pitch (EMC10, 0% mesophase pitch, manufactured by CR-tech) was used instead of the pitch powder of Example 1.

### Example 5

### Manufacture of Lithium Secondary Battery (18650 Mini Full-Cell)

Manufacture of Negative Electrode

The negative active material prepared according to Example 1, graphite, styrene-butadiene rubber (SBR), and carboxymethylcellulose (CMC) were mixed in a photodetector (PD) mixer (manufactured by KM tech) in a weight ratio of 9:88:1.5:1.5 to prepare a negative active material slurry.

The negative active material slurry was coated, to a thickness of 50 μm to 60 μm, onto copper foil having a thickness of 10 μm by using a 3-roll coater and dried, followed by further drying under vacuum at 120° C., to manufacture a negative electrode plate. The negative electrode plate was pressed using a roll press to thereby complete the manufacture of a negative electrode.

Manufacture of Positive Electrode

LiNi_{0.8}Co_{0.15}Al_{0.05}O₂ powder as a positive active material and Denka Black as a carbon conductive material were uniformly mixed, and then a pyrrolidone solution including polyvinylidene fluoride (PVDF) as a binder was added thereto to prepare a positive active material slurry such that a weight ratio of positive active material to carbon conductive material to binder was 97:1.4:1.6.

The positive active material slurry was coated, to a thickness of 70 μm, onto aluminum foil having a thickness of 15 μm and dried, followed by further drying under vacuum at 110° C., to manufacture a positive electrode plate. The positive electrode plate was pressed using a roll press to thereby complete the manufacture of a positive electrode.

Manufacture of Lithium Secondary Battery (18650 Mini Full-Cell)

The negative electrode, the positive electrode, an electrolyte prepared by dissolving LiPF₆ as a lithium salt in a mixed solvent of ethylene carbonate (EC), diethyl carbonate (DEC), and ethyl methyl carbonate (EMC) (a volume ratio of EC:DEC:EMC of 3:5:2) to form a 1.3M solution, and a polyethylene separator were used to manufacture a 18650 mini full-cell. In this regard, the 18650 mini full-cell had a capacity of about 600 mAh/g.

### Examples 6 to 8

### Manufacture of Lithium Secondary Batteries (18650 Mini Full-Cells)

Lithium secondary batteries (18650 mini full-cells) were manufactured in the same manner as in Example 5, except that the negative active materials prepared according to Examples 2 to 4 were respectively used instead of the negative active material of Example 1.

### Comparative Example 2

### Manufacture of Lithium Secondary Battery (18650 Mini Full-Cell)

A lithium secondary battery (18650 mini full-cell) was manufactured in the same manner as in Example 5, except that the negative active material prepared according to Comparative Example 1 was used instead of the negative active material of Example 1.

Analysis of Negative Active Materials

### Analysis Example 1

### Raman Spectroscopy Spectrum Analysis

Raman spectra of the negative active materials of Examples 1 to 4 and Comparative Example 1 were measured using a Raman spectrometer (Micro-Raman Spectrometer, manufactured by Renishaw). The Raman spectra measurement was carried out using an Ar-ion laser with a wavelength of 514.5 nm, in a wavenumber range of 1100 cm⁻¹ to 1800 cm^{-1.}

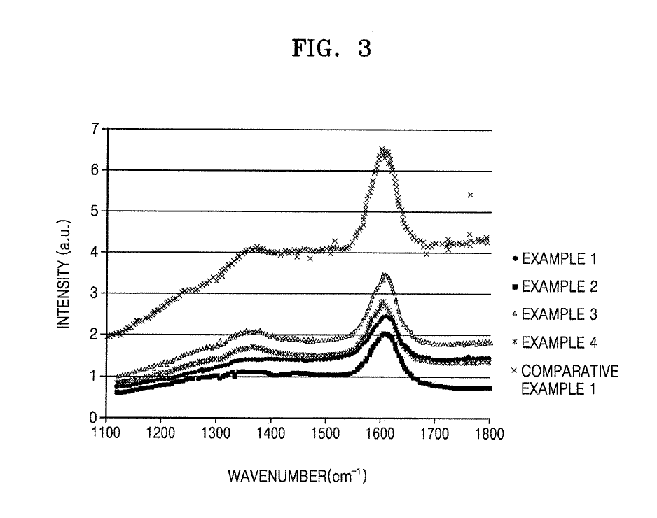

For analysis, a ratio (I_{D}/I_{G}) of intensity (I_{D}) of a peak appearing at about 1300 cm⁻¹ to about 1400 cm⁻¹ to intensity (I_{G}) of a peak appearing at about 1580 cm⁻¹ to about 1620 cm⁻¹ was measured. The results thereof are shown in FIG. 3 and Table 1 below.

TABLE 1

| | Intensity ratio (I_{D}/I_{G}) |
|---|---|
| Example 1 | 1.0 |
| Example 2 | 0.9 |
| Example 3 | 0.7 |
| Example 4 | 0.6 |
| Comparative Example 1 | 1.2 |

As shown in FIG. 3 and Table 1, the ratio (I_{D}/I_{G}) of intensity (I_{D}) of a peak appearing at about 1300 cm⁻¹ to about 1400 cm⁻¹ to intensity (I_{G}) of a peak appearing at about 1580 cm⁻¹ to about 1620 cm⁻¹ of each of the negative active materials of Examples 1 to 4 was 1.0 or less.

The ratio (I_{D}/I_{G}) of intensity (I_{D}) of a peak appearing at about 1300 cm⁻¹ to about 1400 cm⁻¹ to intensity (I_{G}) of a peak appearing at about 1580 cm⁻¹ to about 1620 cm⁻¹ of each of the negative active materials of Examples 1 to 4 was lower than that of the negative active material of Comparative Example 1.

From the results, it is confirmed that the negative active materials of Examples 1 to 4 had a higher intensity (I_{G}) of a peak appearing at about 1580 cm⁻¹ to about 1620 cm⁻¹ than that of the negative active material of Comparative Example 1 and included a carbonaceous material having high crystallinity, i.e., a pitch, in particular, a mesophase pitch.

Battery Performance Evaluation

### Evaluation Example 1

### Evaluation of Charge and Discharge Characteristics-Evaluation of Lifespan Characteristics

The charge and discharge characteristics of each of the lithium secondary batteries (18650 mini full-cells) manufactured according to Examples 5 to 8 and Comparative Example 2 were evaluated using a charger/discharger (manufacturer: HNT, model name: HC1005).

To evaluate the charge and discharge characteristics, an experiment was conducted under the following conditions.

Each of the lithium secondary batteries (18650 mini full-cells) of Examples 5 to 8 and Comparative Example 2 was charged at 0.2 C and at room temperature until the voltage reached 4.2 V and then discharged at a constant current of 0.2 C until a cut-off voltage reached 2.8 V. Charge and discharge capacities (charge and discharge capacities at a 1^{st} cycle) of each lithium secondary battery were measured.

Next, each lithium secondary battery was charged at 1.0 C and at room temperature until the voltage reached 4.2 V and then discharged at 1.0 C until the voltage reached 2.8 V. Charge and discharge capacities at this cycle of charging and discharging of each lithium secondary battery were measured. This cycle of charging and discharging was repeated and discharge capacity at a 100^{th} cycle of each lithium secondary battery was measured.

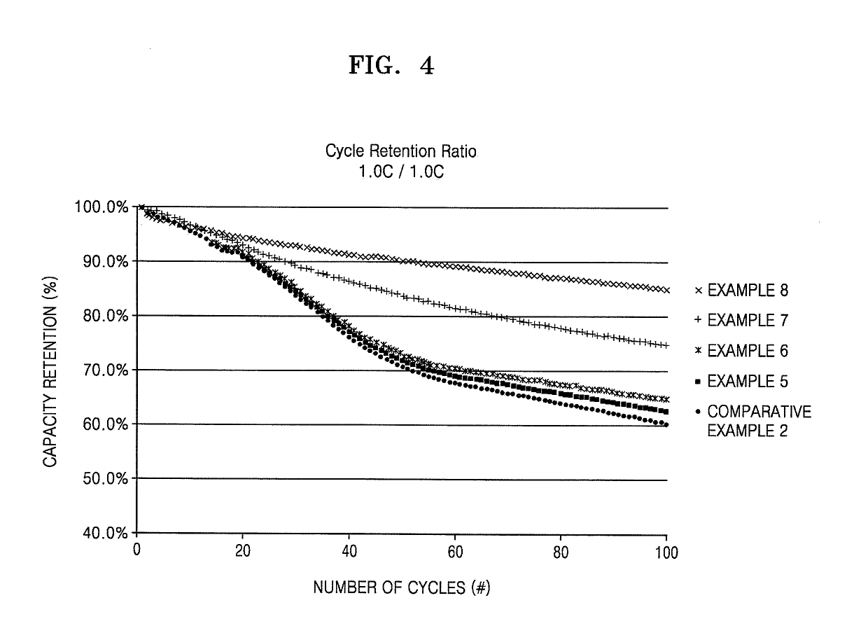

The lifespan characteristics were evaluated from a capacity retention (%), and the cycle retention (%) was calculated by Equation 1 below. The results are shown in FIG. 4 and Table 2 below.

Capacity retention (%)=[(discharge capacity at 100^{th} cycle)/(discharge capacity at 1^{st} cycle)]×100

TABLE 2

| | Capacity retention (%) |
|---|---|
| Example 5 | 62.4 |
| Example 6 | 64.7 |
| Example 7 | 85.0 |
| Example 8 | 74.6 |
| Comparative Example 2 | 60.0 |

As shown in FIG. 4 and Table 2 above, the lithium secondary batteries of Examples 5 to 8 exhibited a higher capacity retention than the lithium secondary battery of Comparative Example 2. The lithium secondary battery of Example 7 had the highest capacity retention among the lithium secondary batteries of Examples 5 to 8.

As is apparent from the above description, a lithium battery that includes a negative active material that includes a pitch coating layer including a mesophase pitch on a surface of a silicon-based material core, according to embodiments may have enhanced lifespan characteristics.

By way of summation and review, carbonaceous negative active materials such as graphite are mainly used as negative active materials of lithium secondary batteries. However, such carbonaceous negative active materials may have a theoretical discharge capacity of only about 360 mAh/g. Silicon-based negative active materials, which have a theoretical discharge capacity of 4200 mAh/g and a high capacity, have been used as an alternative. However, when such silicon-based negative active materials are used alone, the silicon-based negative active materials may undergo volumetric expansion during charging and discharging. Thus, the capacity and lifespan of lithium secondary batteries including the same may rapidly decrease.

Embodiments provide a negative active material with enhanced capacity and lifespan characteristics, a lithium battery including the same, and a method of preparing the negative active material

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A negative active material, comprising:
a silicon-based material core; and
a pitch coating layer on a surface of the silicon-based material core,
wherein the pitch coating layer includes a mesophase pitch.

2. The negative active material as claimed in claim 1, wherein the negative active material has a ratio (I_{D}/I_{G}) of an intensity (I_{D}) of a peak appearing at about 1300 cm⁻¹ to about 1400 cm⁻¹ to intensity (I_{G}) of an a peak appearing at about 1580 cm⁻¹ to about 1620 cm⁻¹ of about 1.0 or less, the intensities of the peaks being measured by Raman spectroscopy spectrum.

3. The negative active material as claimed in claim 1, wherein an amount of the pitch coating layer is from about 1 wt % to about 40 wt % based on a total weight of the silicon-based material core.

4. The negative active material as claimed in claim 1, wherein an amount of the mesophase pitch is from about 30 wt % to about 100 wt % based on a total weight of the pitch coating layer.

5. The negative active material as claimed in claim 1, wherein an amount of the mesophase pitch is from about 30 wt % to about 90 wt % based on a total weight of the pitch coating layer.

6. The negative active material as claimed in claim 1, wherein an amount of the mesophase pitch is from greater than about 70 wt % to about 90 wt % based on a total weight of the pitch coating layer.

7. The negative active material as claimed in claim 1, wherein the silicon-based material core includes one selected from silicon, a silicon-carbon composite, a silicon oxide, a silicon alloy, and combinations thereof.

8. The negative active material as claimed in claim 1, wherein the silicon-based material core includes a silicon-carbon composite.

9. The negative active material as claimed in claim 1, wherein the negative active material has a median particle diameter D50 of about 1 μm to about 20 μm.

10. A lithium battery, comprising:
a negative electrode including the negative active material of claim 1;
a positive electrode including a positive active material; and
an electrolyte between the negative electrode and the positive electrode.

11. A method of preparing the negative active material as claimed in claim 1, the method comprising:
mixing a silicon-based material core and a pitch including a mesophase pitch and compression-molding the mixture to obtain a compression-molded product; and
heat-treating the compression-molded product to prepare the negative active material.

12. The method as claimed in claim 11, wherein the heat-treating is performed in an inert gas atmosphere at a temperature in a range of from about 400° C. to about 1,100° C.

13. The method as claimed in claim 11, wherein the inert gas atmosphere includes one selected from a nitrogen gas atmosphere, a hydrogen gas atmosphere, and combinations thereof.

14. The method as claimed in claim 11, further comprising pulverizing the heat-treated compression-molded product.
